(19) United States
(12) Patent Application Publication
(10) Pub. No.: US 2003/0192416 A1
(43) Pub. Date: Oct. 16, 2003

(54) Appliance for removing the wrapping from bales of agricultural harvested crop

(75) Inventors: Gunter Platon, Klein Denkte (DE); Diethard Tolksdorf, Gross Denkte (DE)

Correspondence Address: SIDLEY AUSTIN BROWN & WOOD LLP, 787 Seventh Avenue, New York, NY, 10019, US

(73) Assignee: Lely Welger Maschinenfabrik GmbH.

(21) Appl. No.: 10/426,532

(22) Filed: Apr. 30, 2003

Related U.S. Application Data
(62) Division of application No. 09/916,797, filed on Jul. 27, 2001.

(30) Foreign Application Priority Data
Jul. 27, 2000 (DE) 100 36 606.6

(51) Int. Cl. B27B 3/00; B26D 7/06

(52) U.S. Cl. 83/733; 83/924

(57) ABSTRACT

An appliance for removing wrapping from bales of agricultural harvested crop and including a knife having a cutting edge directed transverse to the wrapping for cutting through the wrapping upon displacement of the bale and/or the knife, with the knife being displaceable relative at least one side of the bale; and an element for removing a cut wrapping form the bale.

### RELATED APPLICATIONS

This Application is a divisional application of application Ser. No. 09/916,797 filed Jul. 27, 2001.

### BACKGROUND OF THE INVENTION

1. Field of the Invention

The invention relates to an appliance for removing the wrapping from bales of agricultural harvested crop that includes at least one cutting device for slitting or cutting the wrapping and an element for stripping off the cut wrapping.

2. Description of the Prior Art

Such an appliance is described in WO 99/00758, wherein a round bale wrapped in a sheet film is surrounded on three sides by a cutting wire. A drive motor is arranged at each free end, the cutting wire being deflected, approximately 90° at the bale edge and suspended there on springs. In order to separate the sheet film wrapping, the drive motor draws the cutting wire around the bale tightening it inwards towards the center of the bale, so that the wrapping is separated by the resulting compression force. Because the base wrapping systems known in the art produce more overlapping sheet layers on the front side of the bale than on the circumference of the bale, the conventional appliance does not provide consistent separation of the sheet wrapping along the entire intended line of separation. Whereas the circumferential force applied by the cutting wire could conceivably be increased to such a degree that even the relatively thick wrapping on the front side of the bale would be separated, cutting into the bale would be accompanied by the disadvantage that the cutting wire suspension springs would no longer be capable of freeing the cutting wire from its engagement in the bale.

Accordingly, it is the object of the invention to improve the cutting device of the appliance described above.

### SUMMARY OF THE INVENTION

Starting with the device described in the introduction, the problem relating to the cutting device is solved, in that the cutting device is configured as a knife, whose cutting edge is oriented diagonally to the surface of the wrapping and cuts the wrapping as the bale and/or the knife advances along the circumference of the bale or along one or more of the sides of the bale.

Since the separation of the sheet film wrapping according to the invention is accomplished with a knife edge, as is already commonly done in the manual process, the sheet wrapping is cut through simply and with minimum force along the desired line of separation. The displacement force increases only negligibly in the area of greater sheet thickness (multiple sheet film layers) and, because, the cut is made diagonally to the surface, the sheet film is easily separated. Owing to the clean cut, there is also no entanglement of the sheeting in the bale, so that it is more easily removed, from the bale.

In accordance with a particularly advantageous embodiment of the present invention, the operating knife is so arranged that it forms with the surface of the wrapping, in the cutting direction, an angle of less than 90°, so that the wrapping is separated ‘along ’ the cut, with the cut depth of the knife corresponding approximately to the thickness of the wrapping.

The cutting time can be reduced with the bale and the knife moving relative to each other. The removal of the cut wrapping can be effected with at least one driven rotatable member provided with a carrier element.

The appliance can be stationary or movable and includes a frame with driven support elements for supporting and rotating a bale, a knife for separating the wrapping, and at least one element for removing the wrapping.

Advantageously, the appliance includes a frame, which is adapted to be mounted on a lifting device of a tractor and which has at least one driven rotatable arbor extendable through a cylindrical round bale, at least one knife for separating the wrapping, and at least one element for removal of the wrapping from the bale.

Basically, it is possible, according to the present invention, to mount the appliance on a forage distributing or forage mixing trailer and combine it with a bale loading device.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiments, when read with reference to the accompanying drawings.

### BRIEF DESCRIPTION OF THE DRAWINGS

The drawings show:

FIG. 1. a perspective view of a first embodiment of an appliance for removal of a film wrapping of a round bale;

FIG. 2. a plan view of the knife and, the round bale at the beginning of separation of the wrapping along three sides of the bale;

FIG. 3. a side view of the rotatable member with carrier elements for grasping and removing the wrapping;

FIG. 4. a view similar to that of FIG. 2 of the knife, with a bale, of a second embodiment of an appliance for removing a bale wrapping according to the present invention;

FIG. 5. a schematic side view of the Appliance shown on FIG. 1 with two rotatable members with carrier elements for grasping and removing the wrapping;

FIG. 6. a side view of an appliance according to the second embodiment of the present invention without a knife;

FIG. 7. a front elevational view of an appliance according to the present invention for removing a wrapping of a round bale; and

FIG. 8. a plan view of a third embodiment of an appliance for removing a bale wrapping according to the present invention, with a linearly displaceable knife.

### DETAILED DESCRIPTION OF THE PREFERRED EMBODIMENT

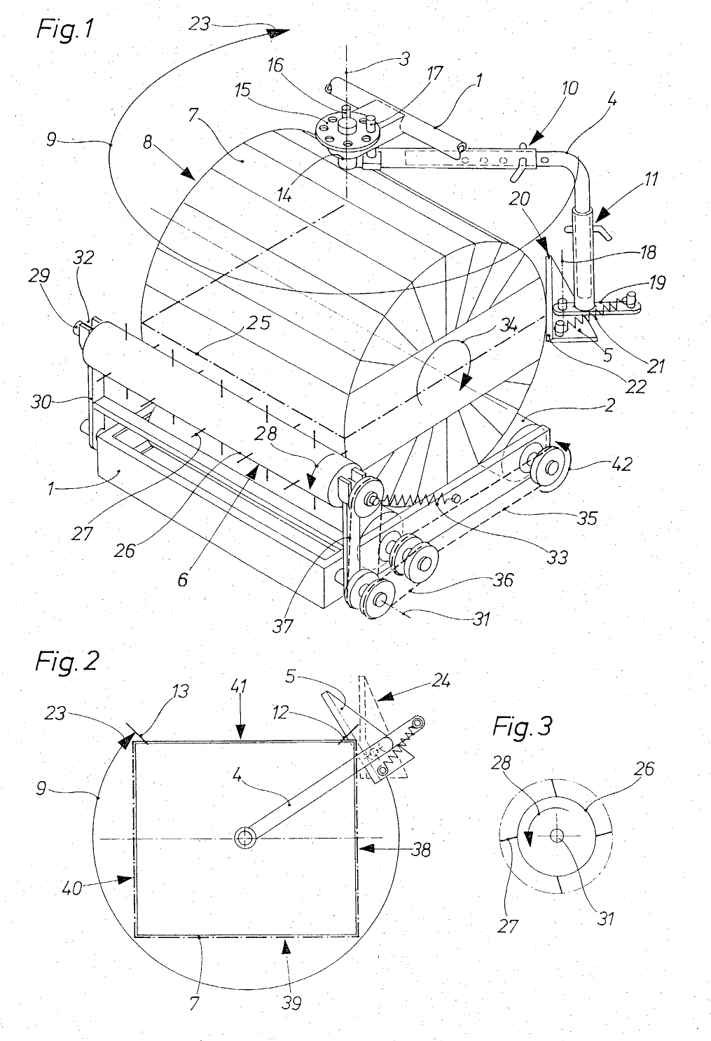

An appliance for removing a round bale wrapping according to the present invention which is shown in FIGS. 1-3, includes a frame 1 carrying two spaced from each other, support rollers 2, a rotatable arm 4 with a knife 5, which rotates about a vertical axis 3, and a rotatable member 6 arranged parallel to the support rollers 2. A cylindrical round bale 8, which is wrapped around with a film material 7, is supported on the support rollers 2. The reference numeral 9 shows a circular trajectory which is described by the rotatable arm 4, together with the knife 5, for cutting the bale wrapping 7. The radius of the rotatable arm 4 and the height of the knife 5 are to so selected, with respect to the support rollers 2, that the rotatable arm 4 can freely circle the bale 8 approximately in its horizontal central plane.

In order to be adapted to different bale diameters, the height of the knife 5, relative to the support rollers 2 and the radius of the rotatable arm 4, are adjusted with slidable guide elements 10 and 11 which can be, locked in predetermined positions. The control of the trajectory, i.e., the initial and end positions 12 and 13, of the rotatable arm 4 can be effected with an arranged above the support 14 of the rotatable arm 4, disc 15 having a predetermined hole pattern and equipped with two sensors 16 and 17. The disc 15 cooperates with the rotatable arm 4 during the rotation of the arm 4, indicating the arm positions.

The knife 5 has a triangular shape and pivots about an axis 18 extending parallel to the rotational axis 3 of the arm 4. The knife 5 is supported on a bracket 19 secured at the lower end of the arm 4. In an operational position 20 of the knife 5, a tension spring 21, which is secured, at one of its ends, to the knife 5 and, at another of its ends, to the bracket 19, biases a cutting edge 22 of the knife 5, which is formed by a cathetus of the knife-forming triangle, against the wrapping film 7 at an angle of less than 90°. Upon rotation of the arm 4 in a direction, which is indicated by arrow 23, the film 7 is draw cut through. It is important that during the entire rotation of the arm 4, a constant or, at critical, points, a higher than constant, cutting force is applied by the knife 5 to the film 7 so that the film 7, is perfectly separated also at the corners, end surfaces, and at the front side of the round bale 8. The mechanical control of the knife 5 can be effected by selecting lever arm ratios and/or points at which the tension spring 19 is connected with the knife 5. The appliance can also include a hydraulic cylinder in combination with a hydraulic accumulator (not shown) which would permit to adapt the knife position to the bale profile. Pivoting of the knife 5 and retaining it in the non-operatinal position 24, which is shown in FIG. 2 with dash lines, can be effected with a hydraulic cylinder or a like device.

Beneath the horizontal central plane of the round bale 8, i.e., beneath the separation line 25 of the wrapping, which is shown with a dash-dot line, there is provided a rotatable member 6 for grasping and removing the wrapping. The rotatable member 6 is formed as a roll 26 with radially projecting prongs 27 the tips of which lead the roll 26 in its rotational direction 28, as shown in FIG. 3. Four rows of prongs 27 are uniformly distributed over the circumference of the roll 26. Each row is formed of a plurality of spaced from each other, prongs 27.

Theoretically, even one row of prongs, which extend in the axial direction of the roll 26, would suffice. The length of the roll 26 is greater than the width of the bale 8, so that the opposite ends of the roll 26, together with the stub shafts 29, project beyond respective ends of the bale 8. The roll 26 is rotatably supported in a pivot frame 30. The pivot frame 30 Is supported, at its lower end and at its axially opposite ends, on the frame 1 for a pivotal movement about an rotational axis 31 extending parallel to the support rolls 2. At its upper end, the pivot frame 30 has upwardly open, U-shaped receptacles 32 in which the stub shafts 29 of the roll 26 engage. A tension spring 33, which is secured at one of its ends, to the pivot frame and at its other end, which is located below the one end, to the frame 1, biases the roll 26 with a slight biasing force against the wrapping beneath the separation line 25, so that the roll 26 resiliently engages the wrapping. Upon rotation of the bale 8 in a direction, which is indicated with an arrow 34, the roll 26 pivots in the direction indicated with the arrow 28. At that, the rotational speed of the prong tips is equal to or greater than that of the bale 8.

The arm 4 is driven, e.g., with a hydraulic motor (not shown). The support rolls 2 are connected with each other by a chain drive 36 likewise driven by a hydraulic motor (not shown). The roll 26 is driven by chain drives 36, 37 which are connected with chain drive 35 of the support rolls 2.

The drive of different elements is coordinated, in course of the described operating sequence by control means (not shown). The appliance can be made stationary, displaceable, or be suspended on a front-end loader. It can also be formed with a three-point hydraulic support. The inventive appliance can be modified for effecting wrapping of a bale with a film. To this end, the knife 5 should be replaced with a stretching unit, and the rotatable member 6 should be replaced with a cutting and binding device. In reverse, a wrapping appliance or appliance can be converted in an appliance for removing the bale wrapping. The appliance can be combined with a bale loading device or be mounted on a forage mixing or distributing trailer, so that the bales can be processed further, without any manual work, immediately after removing their wrapping.

The appliance according to the present invention operates as follows.

After the appliance has been connected, in a per se known manner, with a drive source of a tractor, the bale 8, which is wrapped into a foil 7, is placed on the support rolls 8. With the bale 8 remaining stationary, in the initial position 12 of the arm 4, shown in FIGS. 1-2, the knife 5 cuts into the film 7 with its cutting edge 22 at an end of the bale 8. During the rotation of the arm 4 in the direction, which is indicated with the arrow 23, the cutting edge 22 of the knife 5 draw cuts the wrapping film 7 along the separation line 25. After rotation by an angle of about 270°, the arm 4 reaches its end position; 13 in which it automatically stops. In this position of the arm 4, the wrapping foil 7 is separated into upper and lower halves at three sides 38, 39, and 40, with the fourth side 41 remaining unseparated. Only after the wrapping foil 7 has been separated, at its three sides 38, 39, 40, into the upper and lower halves, the bale 8 is rotated in the direction, which is indicated by the arrow 34, by the drive of the support rolls 2 which rotate in a direction indicated by arrow 42. Simultaneously, the roll 26 starts to rotate in the direction indicated by the arrow 28. The tip of the prongs 27 cut in the film 7 and retain the film 7 during the rotation of the roll 26, so that the film 7 becomes separated from the bale surface, wrapping around the roll 26. The wrapping film 7 is completely separated after several complete rotation of the bale 8. The prong length is so selected that approximately three layers of the wrapping film 7 can be wound off the bale 8 and wound on the roll 26. The roll 26 can easily be taken off the U-shaped receptacles 32 of the frame 30 and replace with a, new roll. The unwrapped bales ban be further processed without any manual work and be loaded, with a front-end loader, in a forage mixing trailer or in another bale processing apparatus. It is also possible to replace the roll with a breaking roll with catches and/or a knife, which permits to provide, in a simple manner, a bale wrapping-unwinding or bale-processing appliance.

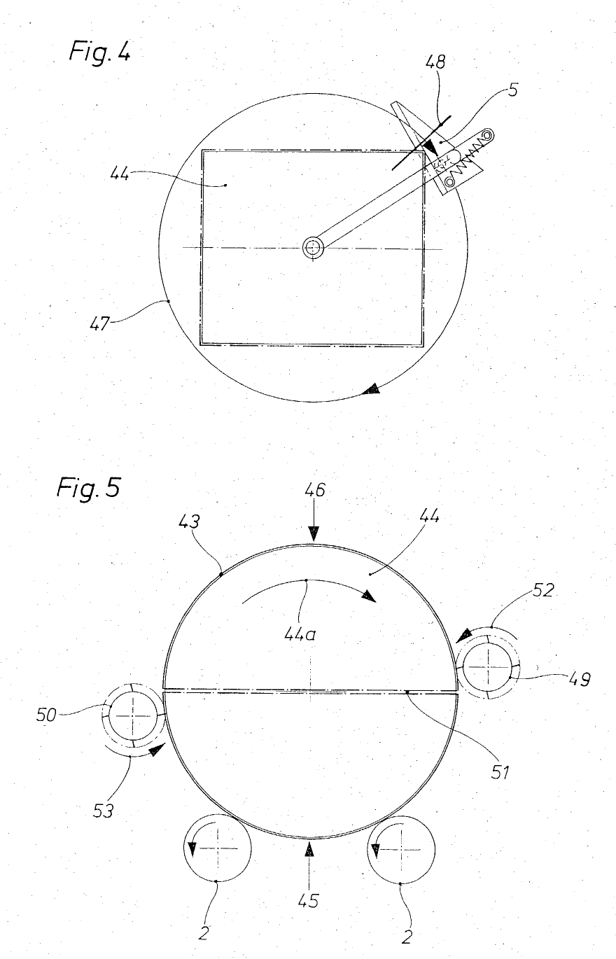

With the embodiment, which is shown in FIGS. 4-5, the separation of the wrapping film 43 takes place along all four sides of the bale 44 in lower and upper halves 45 and 46. As shown in FIG. 4, the arm 4 describes a full circle 47, and the knife 5 circles the bale 44 by 360°, starting from point 48. To insure a reliable separation, the knife 5 runs somewhat past the starting point 48 during the cutting of the film 43.

The grasping and removal of the lower and upper film halves 45 and 46 is effected by rotatable members 50 and 49 which are provided with catching prongs. The upper rotatable member 49 is associated with the upper film half 46 and is located above the separation line 51, and the other, lower rotatable member 50 is associated with the lower film half 46 and is located beneath the separation line 51. The driven support rolls 2 rotate the bale 44 in the direction of the arrow 44a, whereby the driven rotatable members 49 and 50 are rotated in the directions indicated with arrows 52, 53. The rotatable members 49, 50 grasp the ends of respective film halves 46, 45 of the wrapping film 43 and wound them thereon, respectively, over an angle somewhat greater than 180° during one revolution of the bale 4. The film 43 is thereby rapidly removed as each rotatable member 49, 50 has to provide for removal of only half of the wrapping film 43.

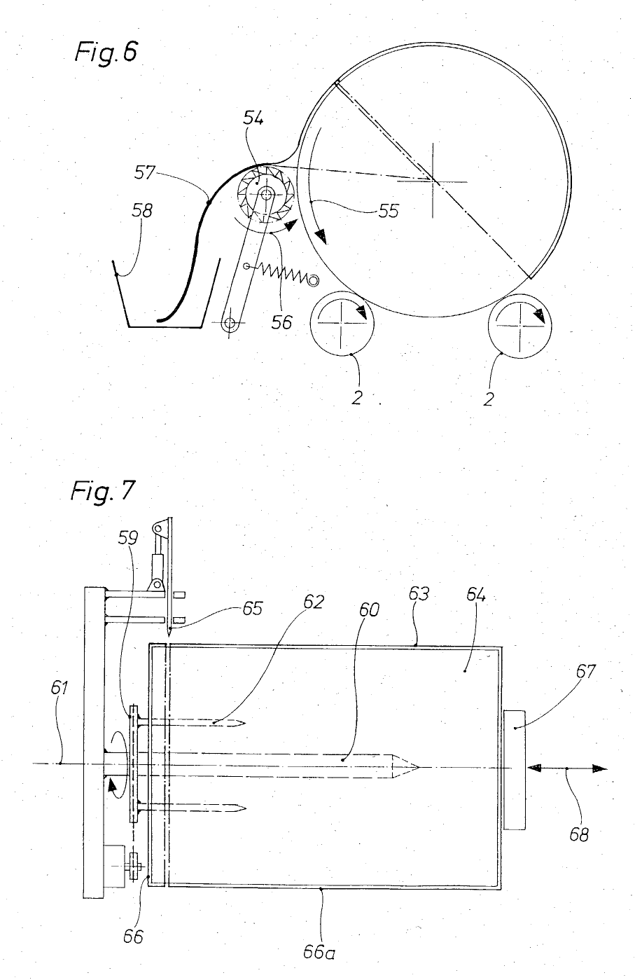

The embodiment shown in FIG. 6 corresponds to that of FIGS. 1-3 and differs from the embodiment of FIGS. 1-3 in that the rotatable member 54 has another direction of rotation 56 with respect to the direction 55 of the bale. The rotatable member 54 grasps the wrapping film 57, which is cut along three sides * and transports it, according to the overhead principle, during the rotation of the bale, into a container 58 or into a film compressing apparatus instead of winding the film on itself After the removal of the wrapping film 57, the appliance of FIG. 6 can be used for unwinding of the bale itself. In this case, the bale is rotated in a direction opposite to the direction it is rotated during the removal of the film.

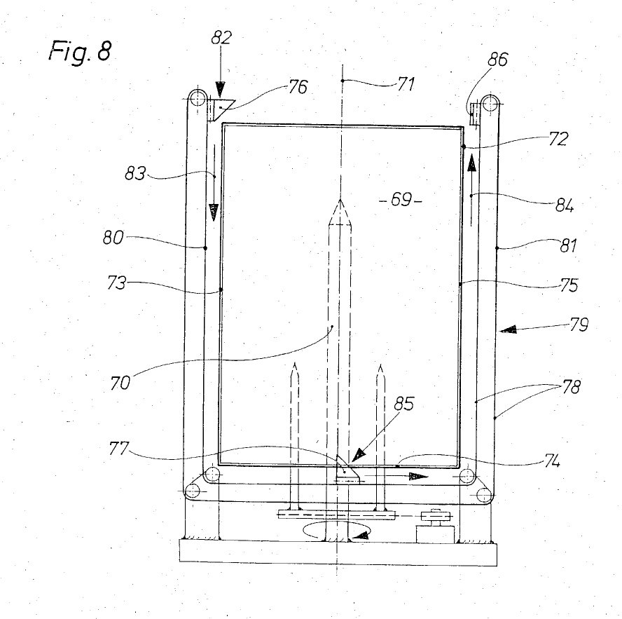

FIG. 7 shows a rotatable drive 59 with an arbor 60 which extends along the axis 61 of the drive 59 and has a pointed tip at its free end. Two retaining arbors 62, which extend parallel to the central arbor 60 are also secured to the disc 59. A bales64, which is wrapped into a film 63, is supported on the arbor 60 in such a way that the arbor 60 extends somewhat along the symmetrical axis of the bale 64. The object of the off-center arbors 62 is to prevent an idle rotation of the arbor 60 in the bale 54 during the rotation of the disc 59 instead of providing the rotation of the bale 64 therewith. The disc 59 is supported in a frame (not shown) which, e.g., can be mounted on a front-end loader of a tractor. At the circumference of the bale 64 adjacent to its end surface, there is provided a cutting tool 65 having an adjustable cutting depth. The cutting tool 65 is supported on a frame. The cutting tool 65 cuts through the end side wrapping film section 66 of the bale 64 along the entire circumference of the bale 64 during the rotation of the bale 64, separating the end side film section 66 from the circumferential film section 66a. For grasping and removing the cap-shaped wrapping film of the bale 64 can, e.g., a suction head 67, per se known, can be used.; The section had 67 reciprocates in directions shown with a double arrow 68. Alternatively or simultaneously the head 67 can be rotatably supported. The bale74 can be unwound upon further rotation of the bale 64 after the wrapping film 63 has been removed.

FIG. 8 shows a bale 69, which is wrapped in a film 72, being supported or arbor 70 similar to the arbor 60 shown in FIG. 7. The bale 70 is lifted by a front-end loader (not shown) so that its rotational axis 71 is somewhat lifted above the ground surface. The cutting of the wrapping film 72 is effected in a horizontal central plane of the bale 69 along three sides 73, 74, 75 of the bale 69 with two linearly displaceable knives 76, 77 in a manner conventional for band knives. The wrapping film 72 remains uncut on the bale end side remote from the arbor 70. As drive means for the cutting knives 76, 77, a link chain, a rack, or a tooth belt/belt: 78, which is connected with a drive (not shown), can be used. The link chain or tooth belt/belt 78 is formed as a U-shaped endless loop 79 with two parallel runs movable in opposite directions. The, loop 79 surrounds the bale 60 along its three sides 73, 74, 75 in the central horizontal plans.: The two cutting knives 76, 77 are supported on an adjacent to the bale 69, run 80 and are so offset relative to each other than each of the knives 76, 77 cuts a half-length of the total length of the film 72 during their linear displacement in directions 83, 84, respectively. Each of the cutting knives 76, 77 is pivotally arranged on the run 80 or on a guide rail (not shown). The knives 76, 77 are deflected, dependant on the run position, e.g., by cams (not shown). The knives 76, 77 are deflected or pivoted away during mounting of the bale 69 on the arbor 70. In FIG. 8, the cutting knives 76, 77 are shown in their initial or starting position 82, 85. Upon actuation of the knife drive, the knives 76, 76 are displaced in the directions shown with the arrows 83, 84. The cutting process stops when the first knife 76 reaches the starting position 85 of the second knife 77 which at that time reaches a position 86. Experiments have shown that both upper and lower wrapping film halves fell downward to the ground upon a short rotation of the bale 69, without a need in any additional elements for grasping and removing the film. Such elements can be used for a short time with certain crops to which the film can adhere.

Though the present invention was shown and described with references to the preferred embodiments, such are merely illustrative of the present invention and are not to be construed as a limitation thereof, and various modifications of the present invention will be apparent to those skilled in the art. It is, therefore, not intended that the present invention be the disclosed embodiments or details thereof, and the present invention includes all variations and/or alternative embodiments within the spirit and scope of the present invention as defined by the appended claims.

What is claimed is:

1. An appliance for removing wrapping from bales of agricultural harvested crop, comprising a knife having a cutting edge directed transverse to the wrapping for cutting through the wrapping upon displacement of at least one of the bale and the knife, with the knife being displaceable relative to at least one side of the bale; and means for removing a cut wrapping from the bale.

2. An appliance as set forth in claim 1, wherein the cutting edge forms with a surface of the wrapping an angle of less than 90° in a cutting direction so that, the wrapping is separated with a draw cut, and wherein the cuffing depth of knife corresponds to a thickness of the wrapping.

3. An appliance as set forth in claim 1, comprising means for displacing the knife around the bale, with the bale remaining stationary.

4. An appliance as set forth in claim 1, further comprising means for retaining the knife in a stationary position with a possibility of a pivotal movement thereat, and means for rotating the bale.

5. An appliance as set forth in claim 1, further comprising means for rotating the bale and the knife in opposite directions, with the wrapping being cut through about a common rotational axis of the bale and the knife.

6. An appliance as set forth in claim 1, further comprising means for bringing the knife into engagement with the wrapping and for disengaging, the knife from the wrapping.

7. An appliance as set forth in claim 1, further comprising means for adjusting a press-on force of the knife during the cutting process.

8. An appliance set forth in claim 7, wherein the press-on force is adjusted depending on at least one of wrapping thickness and a bale profile.

9. An appliance as set forth in claim 1, comprising means for linearly displacing the knife along the at least one side of the bale.

10. An appliance as set forth in claim 1, wherein the removing means comprises a rotatable member.

11. An appliance as set forth in claim 11, wherein the rotatable member is formed, as a roll with radially projecting prongs distributed in, axial and circumferential directions of the roll, with prong tips advancing ahead of the roll in a roll rotational direction.

12. An appliance as set forth in claim 10, wherein the rotatable member resiliently engages a circumference of the bale, which is wrapped with a wrapping film, with the rotatable member engaging the cut wrapping in a region: of a separating line.

13. An appliance as set forth in claim 12, comprising means for rotating the bale and the rotatable member in opposite direction so that the wrapping is roll off the bale and is rolled on the rotatable member.

14. An appliance as set forth in claim 12, comprising means for rotating the, bale and the rotatable member in the same direction so that the wrapping is rolled off the bale and is transported further over the rotatable member according to an overhead principle.

15. An appliance as set forth in claim 12, comprising means for moving the rotatable member around the bale with the bale remaining stationary, so that the wrapping is wound on the rotatable member.

16. An appliance as set forth in claim 12, comprising means for retaining the rotatable member in a stationary position, with a possibility of rotation thereat, and for rotating the bale, whereby the wrapping is wound, upon being removed, on the rotatable member.

17. An appliance as set forth in claim 1, wherein the removing means comprises suction means for removing the wrapping.

18. An appliance as set forth in claim 1, wherein the removing means comprises clamp means for retaining the cut wrapping.

19. An appliance as set forth in claim 1, further comprising a frame, driven support elements mounted on the frame for supporting and rotating the bale, and wherein both the knife and the removing means are mounted on the frame.

20. An appliance as set forth in claim 19, wherein the support elements are arranged in a rotatable table supported for rotation about a vertical axis.

21. An appliance as set forth in claim 1, further comprising a frame mountable on a lifting device of a tractor and including an arbor for piercing the bale, and wherein the knife and the removing means are mounted on the frame.

22. An Appliance as set forth in claim 1, further comprising means for supporting, lifting and unloading a bale.
